(19) United States
(12) Patent Application Publication
(10) Pub. No.: US 2003/0195862 A1
(43) Pub. Date: Oct. 16, 2003

(54) Method and system for providing SQL or other RDBMS access to native xbase application

(76) Inventor: James E. Harrell JR., Atlanta, GA (US)

Correspondence Address: Song K. Jung, LONG ALDRIDGE & NORMAN LLP, Suite 600, 701 Pennsylvania Avenue, N.W., Washington, DC, 20004, US

(21) Appl. No.: 10/119,036

(22) Filed: Apr. 10, 2002

(51) Int. Cl. G06F 17/30; G06F 7/00

(52) U.S. Cl. 707/1

(57) ABSTRACT

A client side, Web server, or clustered server Xbase style data access and transfer system allows native Xbase style application programs to transparently use SQL or other RDBMS style systems as their underlying data store. The system includes a non-flat file client/server storage mechanism as the target data storage system, a native Xbase style application program, script, or Web based application requiring access to a non-Xbase style backend database, and network communications system connecting the two, such as an IP based Ethernet, Web processing system, or other wireless or wired packet switching medium. The native Xbase system connects to the back end application to read and write data as if it were utilizing the native local Xbase desktop database file(s). This allows non-client/server database applications to be easily ported to utilize improved back end servers instead of simple file sharing.

### BACKGROUND OF THE INVENTION

1. Field of the Invention

The present invention relates to database storage and access translation systems, and more specifically to providing remote relational database management system (RDBMS) or structured query language (SQL) type access to native xbase application programs.

2. Discussion of the Related Art

Certain legacy database applications are available that utilize the Xbase programming language or Xbase style flat-file databases for storing and sharing data. Newer and more flexible database servers and RDBMS systems, such as MySQL, ORACLE, and MicroSoft SQL Server provide improved speed, reliability, and remote data access capabilities. Significant work has been performed in the arena of providing SQL transactional integrity and access to native Xbase data sets.

Existing Xbase client/server systems suffer many major functional and performance related drawbacks. Xbase databases are non-relational, flat-file databases. It is well understood that Xbase style databases do not provide optimal functionality in multiple client environments and therefore do not handle concurrent use well. For example, concurrent file access in Xbase style databases rely on operating system (OS) or file system level “locks”. File locking can be problematic and lead to race conditions and corrupted data particularly on shared drives (e.g., web servers, clustered servers, desktop databases, etc.). Even if multiple clients exist on the same host computer, each client that must “open” the database files and database index files utilizes significant memory and processor resources. Xbase style databases are further documented to be poorly suited for high volume or large data set systems. An Xbase database has an inherent limitation in that it can only hold as much data as a single file. Having several clients concurrently opening such large files creates, at a minimum, significant strain on the resources of even a large and powerful server or server cluster. Other drawbacks to Xbase databases include the inability to perform robust searches using relational joins. Xbase style database performance is also reduced when the number of records reaches a critical size.

The similarity and differences of SQL and Xbase style databases has been widely discussed and is well understood, as referenced in U.S. Pat. No. 6,006,229. Microsoft and other vendors have designed methods of hiding such differences (where some still do exist) between SQL and Xbase style databases by providing data access methodology known as Open DataBase Connectivity (ODBC). ODBC provides access to SQL and other relational databases from a standard rowset based interface that is similar to Xbase style commands. Other than causing a degradation in speed over native SQL queries, ODBC does not on its own provide severe limitations in accessing data stores. However, in order for a database application program to connect to an ODBC database the programming methodology and the source code of the database application program must be changed to ODBC.

Given that many Xbase style database application programs still exist today, and that converting them to utilize native SQL or even ODBC data sources can be a difficult, lengthy, and expensive process, a database access method is required that allows native Xbase style application programs to access to remote non-Xbase style databases such as SQL or other RDBMS style data stores.

### SUMMARY OF THE INVENTION

Accordingly, the present invention is directed to a method and system for providing SQL or other RDBMS access to native Xbase application programs that substantially obviate one or more of the problems due to limitations and disadvantages of the related art.

Contrary to the paradigm of ODBC, an advantage of the present invention provides a method of leaving client application program code intact (and possibly never modified) such that the application program continues to virtually manipulate an Xbase data source. The present invention provides a translation layer that replaces an Xbase data source and access libraries. The translation layer accesses and manipulates a remote SQL or other RDBMS style data source. Thus, Xbase style access to SQL or other RDBMS style data store on the database application program on the client side is transparent while data reliability, speed, and remote access capabilities are increased.

Another advantage of the present invention provides a solution to the problem of transparently sending data from the SQL or other RDBMS style server to the client Xbase style application program by providing at least one of an Xbase translation library, a translation kernel, and file system translation modifications which translate native local Xbase requests into SQL or other RDBMS style remote client/server request.

Additional features and advantages of the invention will be set forth in the description which follows, and in part will be apparent from the description, or may be learned by practice of the invention. These and other advantages of the invention will be realized and attained by the structure particularly pointed out in the written description and claims hereof as well as the appended drawings.

To achieve these and other advantages and in accordance with the purpose of the present invention, as embodied and broadly described, a method of providing a client system supporting an application program access to a database includes translating Xbase style function calls from an application program into corresponding SQL or other RDBMS style function calls of a second program structure, wherein the SQL or other RDBMS style function calls are capable of accessing an SQL or other RDBMS style database and the Xbase style function calls cannot. In another aspect of the present invention, a client side data access and transfer system includes a translation library for translating Xbase style function calls of a first program structure from an application program into corresponding SQL or other RDBMS style function calls, wherein the SQL or other RDBMS style function calls are capable of accessing a SQL or other RDBMS style database and the Xbase style function calls cannot.

It is to be understood that both the foregoing general description and the following detailed description are exemplary and explanatory and are intended to provide further explanation of the invention as claimed.

### BRIEF DESCRIPTION OF THE DRAWING

The accompanying drawings, which are included to provide a further understanding of the invention and are incorporated in and constitute a part of this specification, illustrate embodiments of the invention and together with the description serve to explain the principles of the invention.

In the drawings:

FIG. 1 illustrates the functional relationship between a non-relational application program, the translation layer, and the relational data store according to one aspect of the present invention;

FIG. 2 illustrates the division of translating function calls according to another aspect of the present invention;

FIG. 3 illustrates a related system involving the functional relationship between clients and servers;

FIG. 4 illustrates relational database access and manipulation by non-relational database application programs according to one aspect of the first embodiment of the present invention;

FIG. 5 illustrates relational database access and manipulation by non-relational database application programs according to another aspect of the first embodiment of the present invention;

FIG. 6 illustrates relational database access and manipulation by non-relational database application programs according to a second embodiment of the present invention; and

FIG. 7 illustrates relational database access and manipulation by non-relational database application programs according to a third embodiment of the present invention.

### DETAILED DESCRIPTION OF THE ILLUSTRATED EMBODIMENTS

Reference will now be made in detail to embodiments of the present invention, examples of which are illustrated in the accompanying drawings.

According to the principles of the present invention, native Xbase style application programs are allowed to transparently access remote SQL or other RDBMS style database systems. By providing at least one of a translation library, a translation kernel, and file system translation modifications, native local Xbase style data access requests may be translated into SQL or other RDBMS style remote data access requests. Accordingly, native Xbase style application programs may transparently access remote SQL or other RDBMS style database systems.

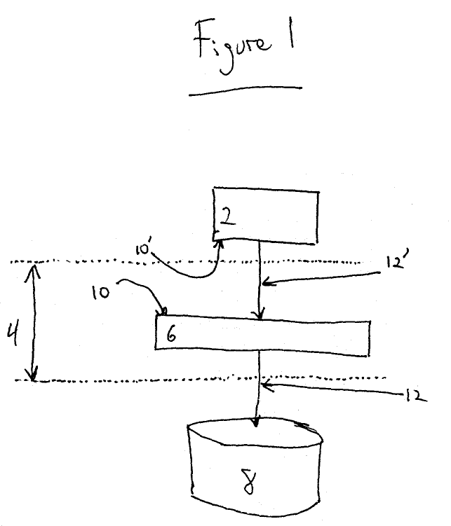

As shown in FIG. 1 according to one aspect of the present invention, the Xbase translation library 6 may be provided within a translation layer 4. The translation library is designed to access and manipulate an SQL or other RDBMS type data source 8 using a translated set of function calls that are supported by Xbase type database application programs 2. Essentially, the translation library presents a superficial replica of the Xbase style database interfaces to the Xbase style application program. Interfaces used in the translation library may be compiled or interpreted, or a combination of the two. The translation library interface 10 is a superficial replica of the Xbase style interface in the sense that the interface of the translation library accepts Xbase style database access and manipulation function calls, which are native to Xbase style database interfaces 10′, and functionally connects the Xbase style function calls to an abstracted version of the Xbase database, wherein the abstracted version of the Xbase database would not otherwise recognize the native Xbase function calls.

Referring still to FIG. 1, using the translation library, all native Xbase style function calls 12′ within the interfaces 10′ of the conventional Xbase style application programs are translated into corresponding function calls 12 for use with abstracted versions of Xbase databases 8, e.g., non-Xbase style databases such as SQL or other RDBMS style databases accessible by the Xbase style application programs via the translation layer 4. By means of a non-limiting example, each Xbase style database may be represented by a corresponding abstracted Xbase database containing one or more SQL or other RDBMS style tables. Meta information of the Xbase style database may be stored in a special system table. For example, index creations corresponding to the Xbase style database index are recorded in meta information tables, but are not directly made into index database “files”. Indexes are created on the SQL tables to mimic the row ordering of the Xbase style database. An optional timestamp field, including information on the last index or row update time, for example, is present to facilitate cache coherence, as will be discussed in greater detail below. Further, each table may be extended with internal use columns for use in special purposes. For example, SQL ID information used in indexed record navigation to uniquely identify a record and optional timestamp information may be present in the internal use columns.

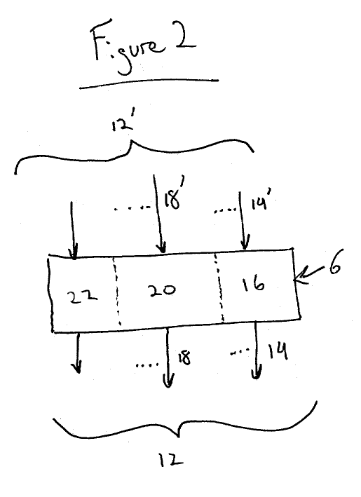

Referring now to FIG. 2, function calls including maintenance function calls 14′ for Xbase style databases may be translated using a maintenance translator 16 including at least one of a SQL/RDBMS database manager library, an Abstract Data Type (ADT), and an Object, e.g., database tables, RDBMS database connection capabilities, etc., provided within the translation library and implemented into the corresponding abstracted Xbase database. The manager library may contain SQL/RDBMS commands for creating and deleting an abstracted database, and creating indexes for the abstracted database. Accordingly, the maintenance function calls from Xbase style application programs are matched to corresponding abstracted database maintenance function calls 14 within the maintenance translator. Thus, the maintenance translator is responsible for providing all maintenance function calls within the abstracted Xbase database and provides compatible Xbase interface-level function calls for use with the abstracted Xbase database. For example, the “create database” Xbase maintenance function call may be translated into a corresponding “create table” SQL function call or other equivalent RDBMS function call to create a remote data storage table, database, or instance. Supported Xbase field types may be translated as necessary to corresponding SQL or RDBMS field definitions. A “create index” Xbase maintenance function call may be translated such that actual indexes on the corresponding SQL tables, databases, or instances of the abstracted Xbase database are created. Additionally, a global record of any special ordering and cross field definitions from the Xbase style database is maintained as a result of translating the “create index” function call. The indexing order, flags, history, control information, and specifications of the Xbase database may be written to and stored in the meta information tables for later use. A “pack database” Xbase maintenance function call may effectively be translated into a “null” function call for use with the abstracted Xbase database. The “pack database” function call is supported within the translation library only in order to provide a consistent interface with the Xbase style application program. SQL and other RDBMS style databases remove records from underlying tables and databases immediately upon execution of a delete command or transaction, therefore “packing” is not necessary in the abstracted database. A “delete database” Xbase maintenance function call may be translated into a function call that removes all instances and references to predetermined abstracted Xbase databases and/or related tables within the abstracted Xbase database.

Referring still to FIG. 2, Xbase style database record navigation, index navigation, “search”, “filter” “view”, “insert”, and “update” function calls 18′ may be translated using a command translator 20 including at least one of a functional access library, ADT, or Object, e.g., SQL definitions, record cursors, navigation pointers, optional client side read-ahead cache, etc., provided within the translation library. Accordingly, the aforementioned function calls from the Xbase style application programs are matched to corresponding abstracted database function calls within the command translator. Thus, the command translator represents and provides translated commands between the Xbase style database or view and the corresponding abstracted Xbase database. The command translator is responsible for providing all abstracted Xbase database record/index navigation, search, filter/view, insert, and update command function calls and may provide compatible Xbase interface-level command function calls for use with the abstracted Xbase database. For example, an “index specification” function call for use with the abstracted Xbase database includes translated Xbase function calls which may be used for specifying a current index used in record navigation within the abstracted Xbase database. The “record navigation” function calls include native translated Xbase function calls for moving to a particular record or moving a predetermined number of records forward or backward, according to a standard database order (non-order navigation) or by a specific, predetermined index. If cursors are not natively supported by the abstracted database, cursor based navigation may still be accomplished via the previously mentioned SQL indexes and IDs stored in the meta information tables. The index order of the abstracted Xbase database may be maintained by a separately generated index database or via SQL “select” and “order” function calls and the use of SQL/RDBMS cursors. A “record search” function call may be provided by the command translator to send native Xbase style search criteria to the abstracted Xbase database. Accordingly, the search criteria originating from the native Xbase application program may be modified and translated as necessary in order to find the specific record in the abstracted Xbase database as indicated by the Xbase style search criteria. Xbase record “filter” and “view” function calls may be applied by the command translator in order to limit the view of the abstracted Xbase database to specific record(s). A “record filter” function call may be provided by the command translator to send native Xbase style filter criteria to the abstracted Xbase database. Accordingly, the filter criteria originating from the Xbase style application program may be modified and translated as necessary in order to create a specific SQL/RDBMS view, cache, or temporary table as indicated by the Xbase style filter criteria. Xbase style function calls for adding, updating, and deleting records are all similarly supported through the translation capabilities of the command translator within the translation library.

Referring still to FIG. 2, in cases where the data server for the abstracted Xbase database does not exist on the host system supporting the Xbase style application program (e.g., the client system), data buffering may be employed using an interface coordinator 22 including at least one of an interface library, ADT, or Object provided within the translation library. Buffering the data may improve overall data transmission performance of the client/server network between the Xbase style application program and the corresponding abstracted Xbase database.

Cache coherency methods may also be applied, as necessary, by the interface coordinator to ensure that changes in shared records are propagated through the system. In one aspect of the present invention, a meta table or time-stamping algorithm may be employed to determine if a local Xbase cache file copy of remote SQL/RDBMS style data is valid or has been modified since the time the cache was last loaded by the client. The meta table may include time stamping algorithms to indicate updates on various tables, indexes, rows or columns within specific rows of data on the remote SQL or RDBMS style storage system.

By means of a non-limiting example, a typical cache coherency method may be applied as follows: a client requests data from a specific row of the abstracted database; in response to the request, the server supporting the abstracted database subsequently loads a file segment containing the specific row; the client reads one page of the file segment; and the client returns an updated version of the row from the loaded page back to the server. Cache coherence is maintained by the table/index level timestamp or by the row level timestamp. Following page fault (e.g., row not present in client cache), the client may request a next page from the segment (assuming coherence is met) without using sophisticated SQL queries that are necessary for index ordering, etc.

Use of the aforementioned cache coherency methods allows multiple concurrent database application programs, which may potentially operate on different systems or platforms, to communicate modification status of data records without requiring knowledge of the specific hosts or database application programs that are concurrently accessing the same data.

A client side caching method may be used to speed up the access to records from the abstracted database. Based on the principle of spatial locality, a library supported by the client may read ahead, in indexed order, a predetermined number of records in a cache. When a cached record is accessed, its timestamp field may be checked for coherence versus the actual record on the server. If the time stamps differ (and if either the server or all clients are enforcing cache coherence), the latest record is retrieved from the server prior to retrieving data to the application program. Accordingly, in the client side caching method, only the time stamp is read, not the entire row associated with the time stamp. A server side caching method may be used in place of, or in combination with, the client side caching method. In the server side caching method, temporary heaps or memory tables may be created on the server to pre-load larger sets of data into RAM located on the server. The client may maintain a Page ID that determines which pages must be pre-loaded on the server (e.g., the client requests a page be pre-loaded on the server RAM).

Referring to FIG. 3, conventional remote data access or manipulation requests may concurrently originate from different users on client PCs 24 either disconnected or connected to the Internet 26 via a Web server 28 (or a cluster of Web servers via a clustering device 30). Accordingly, each of the client PCs connected to the Internet may direct the requests to Web server or Web server cluster, via a clustering device. In response, a Web based application program on the Web server (or Web server cluster) conventionally spawns a common gateway interface (CGI) script interpreter 32 to translate proprietary or open scripting language to access or manipulate database systems. In particular, some of these scripting languages provide commands for accessing and manipulating Xbase databases and indexes. Since multiple clients may be requesting data reads and writes concurrently from different physical locations, the Web servers require concurrent access to the same data. As discussed above, Xbase data storage for such application programs usually exists as a flat-file database on local or peer-to-peer shared file systems, such as MS Windows drive maps or NFS file system shares. Consequently, Xbase data storage systems limit the capabilities for high performance, high volume, or high availability, and/or remote transactional systems, required by the Web servers that access the Xbase data store.

Therefore, in one aspect of the present invention, the Xbase style application programs of the Web server may be enabled to use a centralized RDBMS style data store from a centralized server. In this aspect, RDBMS database access is controlled at the interface of the centralized server through the aforementioned translation layer. Queries and responses between the server hosting the Xbase application program and the centralized RDBMS data store are transmitted within a packet switching medium using, for example, socket connection in TCP/IP or UNIX/STREAM systems. Accordingly, the query load is moved from the Web server to the centralized server. Locking can then be enforced at the centralized server level to avoid concurrent access issues at the Web server level. Under the system of the present invention, an increased number of concurrent requests may be supported by the Web server (or Web server cluster). Data from the centralized server is returned to the translation layer, the translation layer returns the data to the Web server, and the Web server then returns the data to the user at the client PC.

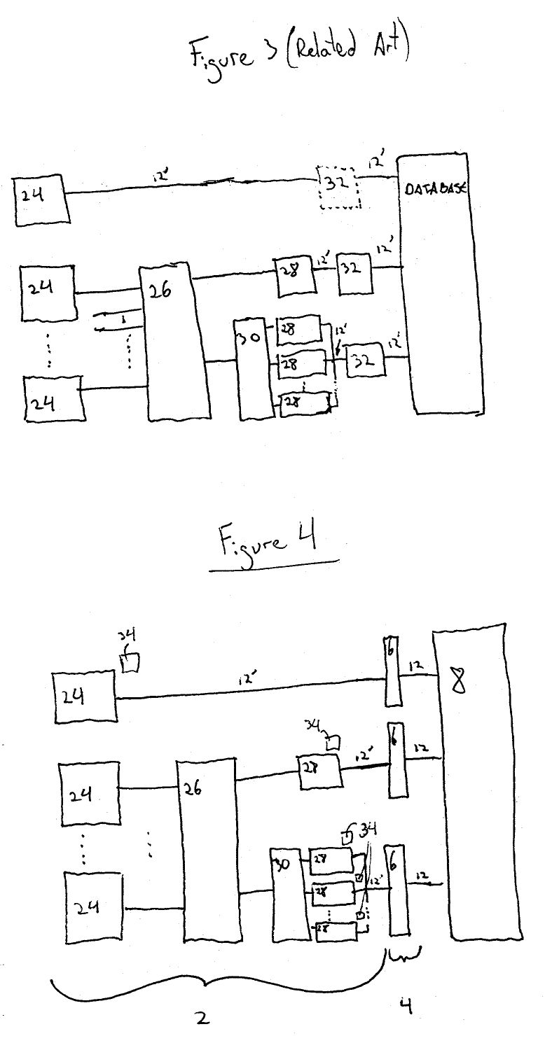

Accordingly as shown in FIG. 4, in a first embodiment of the present invention, access to RDBMS style data stores 8 is provided to one or a plurality of clients (e.g., end-users 24, Web servers 28, clusters 30, etc.) each supporting scripted Xbase style database application programs 2 where the scripted languages do not natively lend themselves to linking against an RDBMS style data source. In the first embodiment of the present invention, source level modifications to the Xbase application programs are made in order to facilitate RDBMS access. The first embodiment of the present invention provides transparent native Xbase data access through a local Xbase cache file of RDBMS data using a translation library 6, a local Xbase cache file 34, and a script rewriting system (not shown). As mentioned above and shown more thoroughly in FIG. 5, the translation library is essentially used in place of a conventional script interpreter and presents an interface 10 that is a superficial replica of the Xbase style interfaces to the existing native Xbase style scripting language. Subservient to the translation library, the script rewriting system alters native Xbase style function calls 12′ within the existing native Xbase style scripting language from a native Xbase access library such that the corresponding function calls 12 from the translation library are used instead of the native Xbase style scripted function calls 12′. In response to the rewritten script, the “current record” 36 (e.g., one row) of any data set is then written into the local Xbase cache file 34 for access and manipulation by the client system. In such a manner, the native script of the application program can virtually read and write to an Xbase database, which, in fact is the abstracted database. In operation, however, any native Xbase style scripted function calls 12′ (e.g., navigation command function calls 18′) or any other function calls that actually commit any data changes to a presumed Xbase style database (i.e., the abstracted database) are re-routed through the translation library. This rerouting process represents an automated, one time rewrite operation that translates the source or script of the Xbase style application program into a format suitable for use with the abstracted database. The one time rewrite operation does not require further changes be made the source or script of the Xbase style application program to utilize the RDBMS style data store. If the translation library does not contain all of the necessary RDBMS style function calls and, thus cannot fully access the RDBMS data store, an external compiled library or program may be provided to supply the missing function calls.

Since, in the first embodiment, the scripted Xbase style application programs only access the data fields of a single current record at any time, the “current record” in the local Xbase cache file is never saved. Accordingly, the local Xbase cache file can be maintained in parallel. This allows Xbase style database application programs to read and write the cached “current record” to a local Xbase cache file using native Xbase data access methods provided by a native command interpreter, while processing any actual record modifications, additions, and/or deletions through the translation library. Cache double buffering techniques, e.g., read-ahead, write-through, etc., may be employed to improve throughput, performance, and data coherence. The double buffering may exist either at the external translation library level, external application program level, or at the script rewriting and local Xbase cache file level. In order to provide concurrent access and cache coherence, record modification is predicated on all fields of the updated record being the same (prior to the update) as when the record is initially cached. Moreover, index, record, or table modification timestamps and cache-dirty flags may be utilized to ensure no external, concurrent updates have occurred since the original record was read into the cache(s).

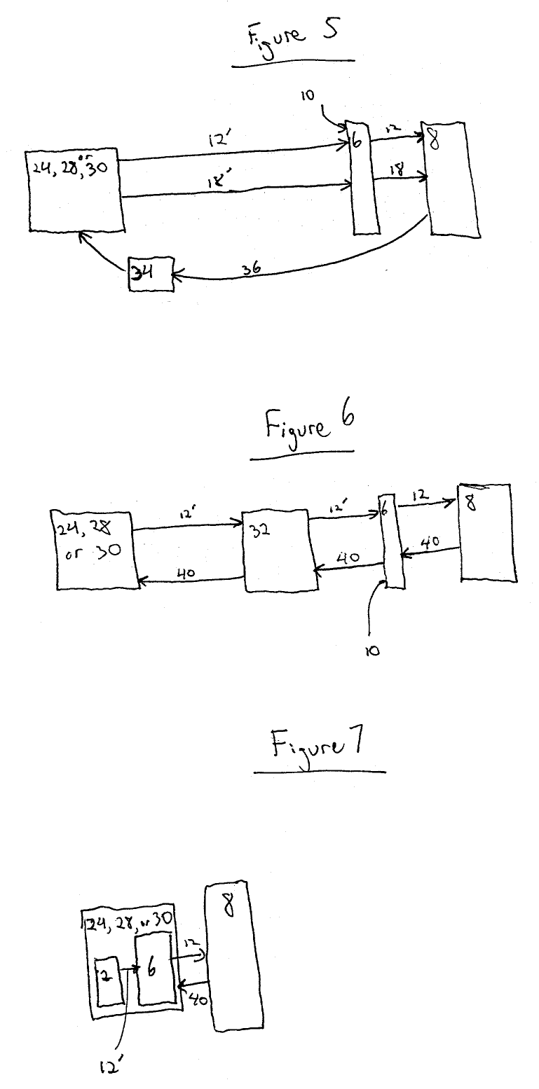

Referring to FIG. 6, a second embodiment of the invention provides link time compatibility for native Xbase style application programs utilizing well specified static or dynamic loaded native Xbase access libraries of the Xbase style application programs by converting the native database access libraries to function calls consistent with the above described translation library. Accordingly, in the second embodiment of the present invention, both transparent client, e.g., end-user, Web server, cluster, etc., access as well as transparent application program level access to SQL or RDBMS data stores may be provided to Xbase style application programs. In this embodiment, Xbase style application programs and/or script interpreters 32 on a client system 24, 28, or 30 that utilize Xbase database access libraries need not be modified at the source level in order to gain the benefits of SQL or other RDBMS style data stores. According to the second embodiment of the present invention, link-time binary compatibility of the translation library 6 provides all of the necessary interfaces 10 required to replace an existing Xbase style database access library. In contrast to the first embodiment, a local Xbase cache file and script rewriting system are not necessary because the scripted language is interpreted by the Xbase style application program to call the translation library (which the Xbase application program sees as a standard Xbase access library) in order to obtain the presumed “Xbase” data. The data 34 is drawn directly from the SQL or RDBMS data store 8 into the client's system utilizing a translation library as described above.

Referring now to FIG. 7, in the case of certain statically linked binary or compiled applications, however, access to or modification of the source or script of database application program or re-linking against the translation library to utilize the translation layer is either not desired or is not possible. Accordingly, in a third embodiment of the present invention, integration of the translation layer 4 at the file system or compiled, kernel level of the operating system may be employed. While dependent upon the operating system specifics, the translation layer essentially intercepts system level I/O commands 12′ used by Xbase access libraries 2. The intercepted I/O commands are re-routed through the translation library 6 introduced at the kernel level. Accordingly, an entirely transparent migration of all Xbase style data sources to SQL or other RDBMS style data sources is provided by the third embodiment of the present invention. Compared to the first and second embodiments, the method of the third embodiment is extremely intrusive at the client (e.g., end-user, Web server, cluster, etc.) operating system level, and is the least intrusive to the native Xbase style application program. In the method of the third embodiment, any Xbase style database application program is enabled to access and manipulate SQL or other RDBMS style data stores without knowledge of the database application program or the application programmer. The third embodiment thus allows existing database application programs to become fully robust SQL or other RDBMS style application programs with zero intrusion or modification to the existing Xbase style application program.

While not intended to limit the scope or spirit of the present invention, the following benefits may be achieved as a result of the present invention. Migration of common database application programs to SQL, RDBMS, or remote client/server application programs may be possible without recompiling or modifying existing code by providing link-time (static and/or dynamic loaded) translation library interfaces, identical to existing Xbase libraries. Operating system or kernel level file access to Xbase style database files may be intercepted and re-routed through the Xbase translation layer. Accordingly, instant access may be provided to remote data stores for existing application programs without the need to recompile or even re-link existing application programs. Conventional functionality limited application programs using desktop database technologies may be migrated to enterprise class application programs with relative ease due to the interface level compatibility provided by any of the aforementioned embodiments of the present invention, or their equivalents. These application programs may thus become robust client/server application programs that increase functionality, reliability, revenue, and market-share that was previously inaccessible for an existing code-base or application program.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents to provide Xbase application program support for access to SQL or other RDBMS data stores.

What is claimed is:

1. A method of providing a client system supporting an application program access to a database, comprising:
translating first function calls of a first program structure from an application program into corresponding second function calls of a second program structure, different from the first program structure, wherein the second function calls are capable of accessing a target database, and wherein the first function calls are incapable of accessing the target database.

2. The method according to claim 1, wherein the first function calls are capable of accessing a non-relational database.

3. The method according to claim 1, wherein the target database is a relational database.

4. The method according to claim 1, wherein the translating comprises:
accepting the first function calls through an interface; and
matching the first function calls with second function calls within a translation library that correspond to the first function calls.

5. The method according to claim 1, further comprising buffering data between the target database and a client system supporting the application program.

6. The method according to claim 1, wherein the translating is performed at a predetermined level, the predetermined level being one selected from the group consisting of scripted, interpreted, and compiled program language levels.

7. The method according to claim 6, further comprising:
translating scripted first function calls into the corresponding second function calls; and
using the corresponding second function calls to generate a data set of the target database within a non-relational intermediate cache file, wherein the intermediate cache file is accessible to a client system supporting the application program.

8. The method according to claim 6, further comprising:
translating interpreted first function calls into the corresponding second function calls; and
using the corresponding second function calls to generate a data set of the target database within a client system supporting the application program.

9. The method according to claim 6, further comprising:
translating compiled first function calls into the corresponding second function calls; and
using the corresponding second function calls to generate a data set of the target database within a client system supporting the application program.

10. The method according to claim 1, further comprising:
using the corresponding second function calls to generate a data set of the target database; and caching information within the data set using at least one of a client side and a server side caching method.

11. A client side data access and transfer system comprising:
a translation library for translating first function calls of a first program structure from an application program into corresponding second function calls of a second program structure, different from the first program structure, wherein the second function calls are capable of accessing a target database and wherein the first function calls are incapable of accessing the target database.

12. The system according to claim 11, wherein the first function calls are capable of accessing a non-relational database.

13. The system according to claim 11, wherein the target database is a relational database.

14. The system according to claim 11, wherein the translation library comprises:
an interface for accepting the first function calls; and
at least one translator selected from the group consisting of a maintenance translator and a command translator for matching the first function calls with corresponding second function calls.

15. The system according to claim 11, further comprising an interface coordinator for buffering data between the target database and a client system supporting the application program.

16. The system according to claim 11, wherein the first function calls are one selected from the group consisting of scripted, interpreted, and compiled first function calls.

17. The system according to claim 16, further comprising:
a script rewriting system for rewriting scripted first function calls; and
a non-relational intermediate cache file accessible to a client system supporting the application program.
